(19) United States
(12) Patent Application Publication
(10) Pub. No.: US 2025/0241297 A1
(43) Pub. Date: Jul. 31, 2025

(54) TERNARY SOLVENT SYSTEMS FOR STABLE PLANT GROWTH REGULATOR FORMULATIONS

(71) Applicant: Rosen's, Inc., Liberty, MO (US)

(72) Inventor: Matthew T Meredith, Spring, TX (US)

(21) Appl. No.: 19/038,553

(22) Filed: Jan. 27, 2025

Related U.S. Application Data
(60) Provisional application No. 63/625,512, filed on Jan. 26, 2024.

(51) Int. Cl. A01N 25/04; A01N 25/30; A01N 43/12; A01N 43/38; A01N 43/90; A01P 21/00

(52) U.S. Cl. CPC A01N 25/04; A01N 25/30; A01N 43/12; A01N 43/38; A01N 43/90; A01P 21/00

(57) ABSTRACT

An agrochemical formulation including one or more plant growth regulators in a ternary solvent system defining an emulsifiable concentrate that is configured to reduce degradation of the plant growth hormone prior to application to plants. The ternary solvent system includes a plurality of non-aqueous solvents, such as a first solvent, a second solvent, and a third solvent. A dielectric constant of the first solvent is greater than a dielectric constant of the second solvent. A dielectric constant of the second solvent is greater than a dielectric constant of the third solvent. At least one plant growth regulator (PGR) or other plant growth hormone and at least one surfactant or emulsifier is dissolved in the ternary solvent system.

### CROSS REFERENCE TO RELATED APPLICATIONS

This patent application claims the benefit of U.S. Provisional Application No. 63/625,512, titled TERNARY SOLVENT SYSTEMS FOR STABILE PLANT GROWTH REGULATOR FORMULATIONS, filed Jan. 26, 2024, the contents of which are expressly incorporated by reference herein.

### TECHNICAL FIELD

The present disclosure is related to agrochemical formulations including plant growth regulators in non-aqueous solutions and emulsions derived therefrom.

### BACKGROUND

Scientists and farmers around the globe strive to generate the highest crop yields per unit area to help feed the growing population of the world. Various agrochemical inputs are used to strengthen plant health and provide nutrients (e.g., fertilizers), control pests (e.g., pesticides), improve soil health (e.g., soil microbes), and improve application of agrochemical inputs (e.g., adjuvants).

Plant growth regulators (PGRs), also referred to as plant growth hormones, are a group of natural chemicals that regulate the different stages of growth in plants and are present in various essential metabolic pathways. Scientific understanding of these hormones has increased rapidly over the last 10 to 20 years, and agroscientists have found that application of these hormones, in certain ratios, at certain stages of plant growth, can have a significant positive effect on growth, plant health, and yield. Over the years, the list of known plant hormones has been growing and now includes, but is not limited to, abscisic acid (ABA), indole-3-acetic acid (IAA or auxin), brassinosteroids (BRs), cytokinin, gibberellic acid (GA), ethylene, jasmonic acid (JA) and salicylic acid.

Prior art in the agrochemical formulations field has focused on which mixtures and ratios of specific hormones give rise to the best growth characteristics, or formulations that enable effective storage, transport, and application of the PGRs. One particular set of three hormones that have been proven to provide increases in plant health and crop yield is a mixture of gibberellic acid (GA), kinetin, and indolebutyric acid (IBA). These three PGRs have been used in various ratios successfully, but one challenge is their chemical stability in aqueous solutions. Water is a desirable solvent, but it facilitates the chemical breakdown of IBA (HORTSCIENCE 25(7):800-802. 1990), and aqueous solutions of gibberellic acid are not stabile in water, with reported degradation half lives of 16 to 24 days (Journal of Environmental Sciences 104 (2021) 1-10). As such, solvent systems that can dissolve these three PGRs and keep them chemically stabile are desirable and difficult to find. Some prior art has focused on glycol or alcoholic solvents, which are polar protic solvent systems able to easily dissolve the PGRs.

One desirable type of formulation would be an emulsifiable concentrate (EC). EC formulations are well-known in the industry and consist of agrochemically active ingredients that are dissolved into an oil or mixture of oils, and emulsifying surfactants. These formulations enable the spontaneous dispersion/emulsification of the mixture into the water of an agricultural spray tank and the oils in an EC formulation can enhance penetration of active ingredients into the target plants. EC formulations are typically used to dissolve agrochemical active ingredients that do not have water solubility, but in this case would be advantageous by providing a non-aqueous environment to enhance PGR chemical stability during product storage and transport. Additionally, during application and use, if the PGR compounds are contained in emulsified oil droplets, their interactions with the aqueous environment of an agricultural spray tank should be reduced, thereby adding stability to the emulsified formulation before spraying.

U.S. Pat. No. 6,756,344 to Killick et al. (hereinafter, Killick), the entire contents of which is incorporated by reference herein, describes lipophilic solvents and fatty amine coupling agents to dissolve large amounts of GA₃ ((3S,3aS,4S,4aS,7S,9aR,9bR,12S)-7,12-Dihydroxy-3-methyl-6-methylene-2-oxoperhydro-4a,7-methano-9b,3-propenoazuleno[1,2-b]furan-4-carboxylic acid). However, the approach in Killick relies on making the GA₃ fatty amine salt, and literature suggests that salts of GA₃ break down faster than the free acid. Killick does not comment on the stability of such a system, nor does the system allow for incorporation of other PGRs.

While EC formulations would be desirable for the reasons listed, many PGRs, including kinetin, IBA, and GA are polar molecules and therefore not soluble in most oils that would be used to create an EC formulation. It is not obvious how to formulate them into a non-aqueous solvent suitable for EC formulations.

### SUMMARY

The present disclosure describes agrichemical formulations and methods utilizing a ternary solvent system that dissolves agronomically relevant quantities of plant growth regulator (PGR) compounds that normally require water or a water-soluble polar protic solvent system to dissolve.

In some examples, the disclosure describes an agrochemical formulation that includes a ternary solvent system, at least one plant growth regulator (PGR) and at least one emulsifier. The ternary solvent system includes a first solvent, a second solvent, and a third solvent. The dielectric constant of the first solvent is greater than the dielectric constant of the second solvent. The dielectric constant of the second solvent is greater than the dielectric constant of the third solvent. The at least one PGR is dissolved in the ternary solvent system. The at least one emulsifier may be configured to form a spontaneous emulsion when the agrochemical formulation is mixed with an aqueous solution, such as water, prior to application to plants.

In some examples, the disclosure describes a technique for producing an agrochemical formulation. The technique includes dissolving at least one plant growth regulator (PGR) in a mixture of a first solvent and a second solvent defining a binary solvent system. A dielectric constant of the first solvent is greater than a dielectric constant of the second solvent. The technique also includes diluting the binary solvent system with a third solvent to form the ternary solvent system. The dielectric constant of the second solvent is greater than the dielectric constant of the third solvent.

In some examples, the disclosure describes a technique for delivering an agrochemical formulation to plants. The technique includes dissolving at least one plant growth regulator (PGR) and at least one emulsifier in a non-aqueous solvent system to produce the agrochemical formulation. The technique also includes adding the agrochemical formulation to an aqueous solution of a spray tank. The agrochemical formulation and the aqueous solution spontaneously form an emulsion defining a spray tank solution. The technique also includes spraying the spray tank solution onto the plants.

### BRIEF DESCRIPTION OF THE DRAWINGS

The disclosure can be understood in consideration of the following detailed description of various embodiments in connection with the accompanying drawings.

FIG. 1 is a conceptual diagram illustrating an example agrochemical formulation.

FIG. 2 is a flow diagram illustrating an example technique for forming an agrochemical formulation.

FIG. 3 is a flow diagram illustrating an example technique for using an agrochemical formulation.

FIG. 4 is a conceptual diagram illustrating results of a replicated yield trial on soybeans.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

The present disclosure describes agrichemical formulations and methods of producing agrichemical formulations utilizing a ternary solvent system. The ternary solvent system includes a plurality of non-aqueous solvents that are selected to dissolve agronomically relevant quantities of select plant growth regulator compounds (PGRs).

The selected PGRs may include, but are not limited to, gibberellins (e.g. Gibberellic acid (GA3), Gibberellin A₄ (GA4), and Gibberellin A₇ (GA7), cytokinins (e.g., kinetin), and auxins (e.g., indole-3-butyric acid).

The selected PGRs may normally require water or a water-soluble polar protic solvent system to dissolve. Surprisingly, however, select PGRs, including, for example, gibberellic acids, cytokinins, and auxins, are soluble in the described ternary solvent system having at least three solvents, each with different dielectric constants (ϵ). For example, the ternary solvent system may include a high dielectric polar aprotic solvent (ϵ>30), a medium dielectric constant solvent (12<ϵ<25), and a low dielectric constant solvent (ϵ<5).

As used herein, the terms high dielectric constant, medium dielectric constant, and low dielectric constant express the relation of dielectric constant of a select solvent relative to other solvents in the system. Additionally, dielectric constants are expressed at a standard temperature of 25° C.

Examples of high dielectric solvents include, but are not limited to, dimethyl sulfoxide (DMSO), dimethylformamide (DMF), N-methylpyrrolidone (NMP), dimethylacetamide (DMAc), nitrobenzene, propylene carbonate (PC), and acetonitrile.

Examples of medium dielectric solvents include, but are not limited to, acetone, methyl ethyl ketone, isopropanol, ethyl lactate, a N,N-dimethyl amide, a mixture of N,N-dimethyl amides, N,N-dimethyloctanamide, N,N-dimethyldecamide, 2,2-Dimethylpropanamide, 1-Pentanol, 2-Methyl-1-butanol, 1,2-Pentanediol. A N,N-dimethyl amide or a mixture of N,N-dimethyl amides may include the following compounds:

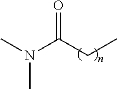

where n is 6-10,

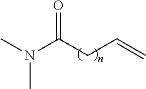

where n is 5-9, or combinations thereof.

Examples of low dielectric solvents include, but are not limited to, vegetable oils, esterified vegetable oils, paraffinic oils, and aromatic oils.

The ternary solvent system includes select ratios of the plurality of non-aqueous solvents. In some examples, an agrochemical formulation may include a high dielectric solvent within a range from approximately 5 volume percentage (vol. %) to approximately 15 vol. % of the agrochemical formulation, a medium dielectric solvent within a range from approximately 35vol. % to approximately 50 vol. % of the agrochemical formulation, and a low dielectric solvent within a range from approximately 30 vol. % to approximately 45 vol. % of the agrochemical formulation. As used herein, the term approximately may include a positive or negative variation in the stated value due to limitations of measurement devices, significant figures, or other means of error, such as, for example, a 5% variation or a 10% variation.

In some examples, the ratios of the plurality of non-aqueous solvents may be selected based on a relative amount and type of PGR compound selected for the agrochemical formulation. For example, an amount (e.g., vol. %) of a high dielectric solvent may be selected to fully dissolve selected amounts (e.g., vol. %) of one or more PGRs of the plurality of selected PGRs, which may only be soluble, or at least more soluble in, the high dielectric solvent. Additionally, an amount of (e.g., vol. %) of a medium dielectric solvent and/or a low dielectric solvent may be selected for similar reasons. For example, kinetin and GA₃ are readily soluble in DMSO (3.3%, and 1.5%, respectively), but virtually insoluble in vegetable oil or modified vegetable oil solvents.

In some examples, the plurality of non-aqueous solvents and ratios thereof may be selected for desired agrochemical properties. For example, esterified vegetable oil may be selected as a low dielectric solvent in an amount greater than an amount of either a high dielectric solvent or a medium dielectric solvent. The incorporation of the high level of esterified vegetable oil may improve penetration into target plants of the agrochemical formulations. In this way, the composition of the agrochemical formulation may improve effectiveness for treating plants.

In some examples, the plurality of non-aqueous solvents and ratios thereof may be selected to reduce or otherwise delay degradation of some PGRs. For example, polar protic solvents and polar aprotic solvents including but not limited to water and DMSO or other high dielectric solvents may denature or degrade some sensitive PGRs. Therefore, when including such sensitive PGRs, a type and an amount of the high dielectric solvent (or other solvent) may be selected to reduce denaturing or degradation of the sensitive PGR. Additionally, or alternatively, when preparing an agrochemical formulation, the sensitive PGR may be first mixed with a less polar solvent and then added to other components of the agrochemical formulation that may include more polar solvents. In these ways, selection and mixing of solvents may be controlled to limit denature or degradation of select PGRs.

In some examples, the plurality of non-aqueous solvents and ratios thereof may be selected to optimize the cost and sustainability of the formulation. For example, most high-dielectric solvents are higher cost, relative to low-dielectric solvents such as vegetable oils or modified vegetable oils. Therefore, it may be advantageous to optimize a ternary solvent system to limit the amount of high dielectric solvent and maximize the amount of low dielectric solvent. Vegetable oils and their derivatives may be naturally sourced and renewable, compared high-dielectric solvents such as DMSO or NMP, which are synthetically produced via energy-intensive processes that produce chemical waste byproducts. As such, maximizing low dielectric solvent content may enable the inventive products to minimize contributions to hazardous waste and greenhouse gas emissions.

Although the agrochemical formulations described above include three non-aqueous solvents, in other example, an agrochemical formulation may include only two solvents while maintaining the above-described benefits. For example, an agrochemical formulation may include a high dielectric solvent with one of a medium dielectric solvent or a low dielectric solvent, or a medium dielectric solvent with one of a high dielectric solvent or a low dielectric solvent.

The agrochemical formulations described herein also include at least one emulsifier configured to enable the agrochemical formulation to spontaneously form an emulsion when added to an aqueous solution. Theat least one emulsifier may include any suitable single or combination of emulsifying surfactants.

The at least one emulsifier may be selected to have any suitable properties to enable the spontaneous formation of the emulsion. For example, the at least one emulsifier may be anionic, nonionic, or cationic. In some examples, the at least one emulsifier may include a mixture of nonionic and anionic emulsifying surfactants. In some examples, the hydrophilic-lipophilic balance, indicative of the extent to which the hydrophilic or lipophilic character dominates, may be between approximately 10 to approximately 18 or otherwise suited to emulsify the ternary solvent system in the aqueous solution.

The amount of the at least one emulsifier may be selected to provide for spontaneous emulsion of the ternary solvent system when mixed with an aqueous solution, such as a water-based spray for application to crop plants. In some examples, an agrochemical formulation may include the at least one emulsifier within a range from approximately 8 vol. % to approximately 15 vol. % of the agrochemical formulation.

The flowing examples illustrate example agrochemical formulations described herein.

Comparative Example 1: A combination of three PGRs (kinetin, GA3, and IBA) were dissolved in water along with a defoamer and a phosphate ester surfactant at the ratios specified in Table CE1:

TABLE CE1

| Component | Vol. % |
|---|---|
| Kinetin | 0.0091% |
| GA3 | 0.0054% |
| IBA | 0.00510% |
| Phosphate ester surfactant | 1.00% |
| Antifoam | 0.05% |
| Water | balance |

Formulation CE1 was analyzed for the three PGRs after 1 year of storage and the detected levels of active ingredients were as follows: kinetin 0.0015% (83% loss), GA3 0.0005% (91% loss), and IBA not detected (100% loss). This is typical behavior for an aqueous system containing these PGRs.

Example 1 (E1): A combination of three PGRs (kinetin, GA3, and IBA) were dissolved in a ternary solvent system containing a high dielectric solvent (DMSO), a medium dielectric solvent (HALLCOMID® M-8-10), and a low dielectric solvent (methyl soyate) with surfactants (ETHOX® CO-40 and ETHFAC® 140) at the ratios specified in Table E1:

TABLE E1

| Component | Vol. % |
|---|---|
| Kinetin | 0.10% |
| GA3 | 0.050% |
| IBA | 0.050% |
| DMSO | 11.00% |
| HALLCOMID ® M-8-10 | 41.80% |
| Methyl Soyate | 35.00% |
| ETHOX ® CO-40 | 9.00% |
| ETHFAC ® 140 | 3.00% |

HALLCOMID® M 8-10 is commercially available from Stepan Company located in Northbrook, Illinois. ETHOX® CO-40 and ETHFAC® 140 are commercially available surfactants from Ethox Company located in Greenville, South Carolina.

The formulation when added to water forms a spontaneous, stable emulsion.

The formulation was tested in an accelerated aging test by storing the sample at 54° C. for 2 weeks and measuring the content of the PGRs before and after testing. This was to follow the EPA's Office of Pesticide Programs guidelines for product chemistry and stability.

Table 2 illustrates initial formulation stability and stability at two-weeks as a percentage change in the amount (vol. %) of each PGR:

TABLE 2

| Component | Initial Assay | 2-Weeks at 54° C. | Percent Change |
|---|---|---|---|
| GA3 | 0.058% | 0.055% | 5.17% |
| IBA | 0.047% | 0.047% | 0.00% |
| kinetin | 0.099% | 0.090% | 9.09% |

As illustrated in Table 2, the stability imparted by the formulation limited the degradation of the three PGRs to less than 10% over the course of the test. This stability is exceptional and would enable the formulation to pass the EPA accelerated aging storage stability test.

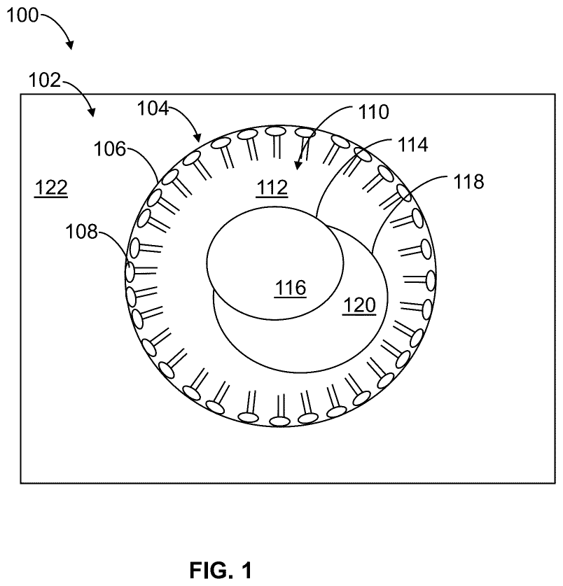

FIG. 1 is a conceptual diagram illustrating an example emulsion 100 including an aqueous solution 102 and an agrochemical formulation 104. Emulsion 100 is configured to be applied to plants by spraying or other suitable means. Aqueous solution 102 includes a suitable solution of water and other optional water-soluble additives as a carrier for delivery of agrochemical formulation 104 to one or more selected portions of plants. Agrochemical formulation 104 may be the same as or substantially similar to the agrochemical formulations described above. For example, agrochemical formulation 104 includes a ternary solvent system, at least one PGR, and at least one emulsifier.

In some examples, emulsion 100 may be prepared by mixing of aqueous solution 102 and agrochemical formulation 104. During mixing, aqueous solution 102 and agrochemical formulation 104 may spontaneously form emulsion 100. Mixing may be performed within a threshold duration of time prior to spraying or during a spraying process via static mixers or other fluid mixing devices. The threshold duration of time between mixing and spraying may be selected to reduce or prevent substantially degradation of one or more components of agrochemical formulation 104 prior to spraying. Example threshold durations of time may be, for example, less than one hour, less than five hours, less than 12 hours, or less than 24 hours. Substantial degradation of one or more components of agrochemical formulation 104 may include selected amount of change, denaturation, or deactivation of the one or more components of agrochemical formulation 104, such as for example greater than 1 vol. % change, greater than 5 vol. % change, greater than 10 vol. %, or greater than 20 vol. %.

Upon mixing, aqueous solution 102 and agrochemical formulation 104 form a plurality of micelles, such as micelle 106. Micelle 106 includes an aggregate of surfactant molecules 108 encapsulating a portion of the non-aqueous agrochemical formulation 104. Micelle 106 may reduce or prevent diffusion of constituents 122 of aqueous solution 102 into agrochemical formulation 104, or vice versa. For example, a concentration of a constituent 122, such as iron or manganese, of aqueous solution 102 may be greater than a concentration of the constituent in agrochemical formulation 104. Such constituents may degrade or denature respective PGRs, therefore, controlling diffusion of the constituent from aqueous solution 102 to agrochemical formulation 104 may provide improved chemical stability of the respective PGRs compared to other systems without micelles 106.

The portion of agrochemical formulation 104 may include one or more regions, each region having a respective profile of the constituent components of agrochemical formulation 104. For example, a first region 110, the interfacial region, may include a greater concentration of at least one solvent of the ternary solvent system and/or one or more emulsifying surfactants compared to a second region 114 and a third region 118. In some examples, the greater concentration of the at least one solvent may be due to interaction of the solvent with hydrophobic tails of the surfactant molecules, the other solvents of the ternary solvent system, or both. Similarly, second region 114 and third region 118 may include a greater concentration of at least one respective solvent of the ternary solvent system compared to the other regions.

Additionally, or alternatively, each of first region 110, second region 114, and third region 118 may include a greater concentration of respective PGRs of the at least one PGR compared to the other regions. In some examples, the greater concentration of the respective PGRs may be due to interaction of the PGRs with the solvents in the respective region. For example, first region 110 may have a first concentration 112 of respective PGRs, second region 114 may have a second concentration 116 of respective PGRs, and third region 118 may have a third concentration 120 of respective PGRs. In some examples, the respective PGRs may be more chemically stabile in the respective regions. In this way, the agrochemical formulation 104 may reduce denaturation or degradation of the respective PGRs compared to unitary or binary solvent systems.

In some examples, a respective region may act as a buffer to reduce or prevent diffusion of other constituents, such as constituents 122 of aqueous solution 102, into other regions. For example, first region 110 may reduce or prevent diffusion of constituents 122 into second region 114, third region 118, or both.

Although illustrated as distinct regions that may be concentric or partially concentric, regions 110, 114, and 118 may define concentration gradients of constituent components rather than distinct boundaries. In other examples, agrochemical formulation may not include such regions.

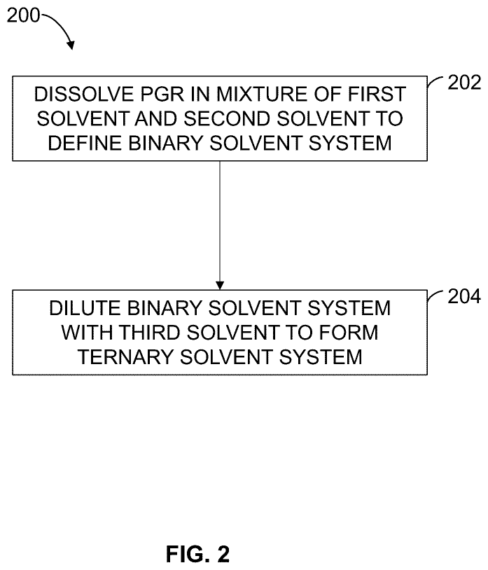

FIG. 2 is a flow diagram illustrating an example technique 200 for forming an agrochemical formulation. Although technique 200 is described in reference to the agrochemical formulations discussed above, the technique may be used to form other agrochemical formulations. Additionally, the agrochemical formulations described herein may be formed by other techniques.

Technique 200 includes dissolving at least one plant growth regulator (PGR) in a mixture of a first solvent and a second solvent defining a binary solvent system (202). The dielectric constant of the first solvent may be greater than the dielectric constant of the second solvent. For example, the first solvent may include a high dielectric solvent, as discussed above, e.g., having a dielectric constant greater than approximately 30. Also, the second solvent may include a medium dielectric solvent, as discussed above, e.g., having a dielectric constant within a range from approximately 12 to approximately 25.

Technique 200 also includes diluting the binary solvent system with a third solvent to form the ternary solvent system (204). The dielectric constant of the second solvent may be greater than a dielectric constant of the third solvent. For example, the third solvent may include a low dielectric solvent, as discussed above, e.g., having a dielectric constant less than approximately 5.

In some examples, technique 200 may include mixing at least one surfactant, such as at least one emulsifier, with at least one of the binary solvent system (step 202), the ternary solvent system (step 204), or both. As discussed above, the at least one surfactant may include an anionic surfactant, a nonionic surfactant, a cationic surfactant, or combinations thereof.

In some examples, technique 200 may include packaging the agrochemical formulation. For example, the technique may include dispensing the agrochemical formulation into a container, optionally purging oxygen gases from the container such as with introduction of nitrogen gas, and sealing the container with a foil seal, polymer seal, cap, or the like.

In some examples, technique 200 may include introducing to the agrochemical formulation one or more additives such as fertilizers, biostimulants, adjuvants, beneficial soil microbes, minerals, preservatives, or the like. Technique 200 also may include introducing the agrochemical formulation into an aqueous solution to form an emulsion.

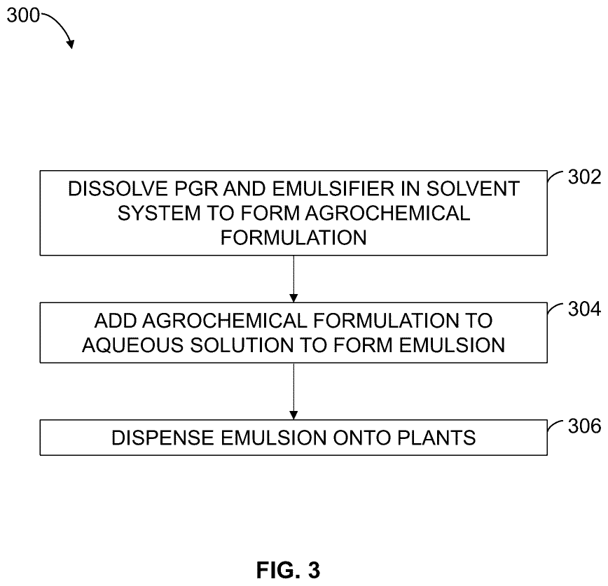

FIG. 3 is a flow diagram illustrating an example technique 300 for using an agrochemical formulation. Although technique 300 is described in reference to the agrochemical formulations discussed above, the technique may be used to form other agrochemical formulations. Additionally, the agrochemical formulations described herein may be applied to plants using other techniques.

Technique 300 includes dissolving at least one plant growth regulator (PGR) and at least one emulsifier in a non-aqueous solvent system to produce the agrochemical formulation. In some examples, dissolving the at least one PGR and at least one emulsifier in the non-aqueous solvent system may include dissolving at least one plant growth regulator (PGR) in a mixture of a first solvent and a second solvent defining a binary solvent system, diluting the binary solvent system with a third solvent to form the ternary solvent system, and dissolving the at least one emulsifier in one of the binary solvent system or the ternary solvent system. As discussed above, the first solvent may include a high dielectric solvent (e.g., having a dielectric constant greater than approximately 30), the second solvent may include a medium dielectric solvent (e.g., having a dielectric constant within a range from approximately 12 to approximately 25), and the third solvent may include a low dielectric solvent (e.g., having a dielectric constant less than approximately 5). Additionally, the at least one emulsifier may include any suitable surfactant or combination of surfactants. Such surfactants may include, for example, an anionic surfactant, a nonionic surfactant, a cationic surfactant, or combinations thereof.

Technique 300 also includes adding the agrochemical formulation to an aqueous solution. In some examples, the aqueous solution may be an aqueous solution in a spray tank. The agrochemical formulation and the aqueous solution may spontaneously form an emulsion defining a spray tank solution. In some examples, technique 300 also may include mixing water with one or more additives, as discussed above, to produce the aqueous solution.

Technique 300 also includes spraying the spray tank solution onto plants or seeds. Spraying may include any suitable spraying technique or spraying system including, but not limited to, backpack sprayers, spot sprayer, all-terrain vehicle or utility terrain vehicle sprayers, manned or unmanned aerial vehicle sprayers, tow behind sprayers, truck bed sprayers, 3-point hitch sprayers, boom sprayers, boomless sprayers, or mist sprayers.

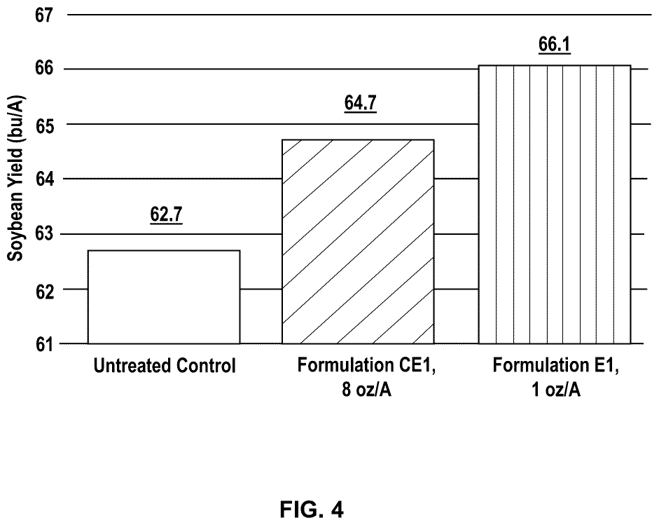

FIG. 4 is a conceptual diagram illustrating results of a replicated yield trial on soybeans using formulations Comparative Example 1 (CE1) and Experimental 1 (E1), as indicated in Tables CE1 and E1 above, respectively. As illustrated in FIG. 4, an increase in yield was observed for each formulation. Formulation E1 was applied at a lower rate to balance for the higher concentration of PGRs versus CE1.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. An agrochemical formulation comprising:
a ternary solvent system comprising a first solvent, a second solvent, and a third solvent, wherein a dielectric constant of the first solvent is greater than a dielectric constant of the second solvent, and wherein a dielectric constant of the second solvent is greater than a dielectric constant of the third solvent;
at least one plant growth regulator (PGR) dissolved in the ternary solvent system; and
at least one emulsifier.

2. The agrochemical formulation of claim 1, wherein:
the dielectric constant of the first solvent is greater than approximately 30;
the dielectric constant of the second solvent is within a range from approximately 12 to approximately 25; and
the dielectric constant of the third solvent is less than approximately 5.

3. The agrochemical formulation of claim 1, wherein:
the first solvent is approximately 5 volume percent (vol. %) to approximately 15 vol. % of the agrochemical formulation;
the second solvent is approximately 35 vol. % to approximately 50 vol. % of the agrochemical formulation; and
the third solvent is approximately 30 vol. % to approximately 45 vol. % of the agrochemical formulation.

4. The agrochemical formulation of claim 1, wherein the first solvent comprises at least one of dimethyl sulfoxide (DMSO), N,N-dimethylformamide (DMF), N-methyl-2-pyrrolidone (NMP), propylene carbonate, and 1,3-Dimethyl-2-imidazolidinone.

5. The agrochemical formulation of claim 1, wherein the second solvent comprises an N,N-dimethyl amide or a mixture of N,N-dimethyl amides according to 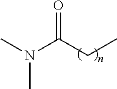
where n is 6-10, or 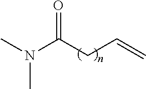
where n is 5-9.

6. The agrochemical formulation of claim 1, wherein the third solvent comprises at least one of a vegetable oil, an esterified vegetable oil, a paraffinic oil, and an aromatic oil.

7. The agrochemical formulation of claim 1, wherein the at least one emulsifier comprises an anionic surfactant and a nonionic surfactant.

8. The agrochemical formulation of claim 1, wherein the at least one PGR comprises at least one of a gibberelin, a cytokinin, a auxin, GA3, GA4, GA7, kinetin, indole-3-butyric acid, cis-jasmone, brassinosteroids, salicylic acid, and methyl salicylate.

9. A method of producing an agrochemical formulation, wherein the method comprises:
dissolving at least one plant growth regulator (PGR) in a mixture of a first solvent and a second solvent defining a binary solvent system, wherein a dielectric constant of the first solvent is greater than a dielectric constant of the second solvent; and
diluting the binary solvent system with a third solvent to form the ternary solvent system, wherein a dielectric constant of the second solvent is greater than a dielectric constant of the third solvent.

10. The method of claim 9, wherein the method further comprises mixing at least one emulsifier with at least one of the binary solvent system and the ternary solvent system, and wherein the emulsifier comprises an anionic surfactant and a nonionic surfactant.

11. The method of claim 9, wherein:
the dielectric constant of the first solvent is greater than approximately 30;
the dielectric constant of the second solvent is within a range from approximately 12 to approximately 25; and
the dielectric constant of the third solvent is less than approximately 5.

12. The method of claim 9, wherein:
the first solvent is approximately 5 volume percent (vol. %) to approximately 15 vol. % of the agrochemical formulation;
the second solvent is approximately 35 vol. % to approximately 50 vol. % of the agrochemical formulation m; and
the third solvent is approximately 30 vol. % to approximately 45 vol. % of the agrochemical formulation.

13. The method of claim 9, wherein the method further comprises providing the first solvent comprising at least one of dimethyl sulfoxide (DMSO), dimethylformamide (DMF), N-methyl-2-pyrrolidone (NMP), and propylene carbonate.

14. The method of claim 9, wherein the method further comprises providing the second solvent comprising an N,N-dimethyl amide or a mixture of N,N-dimethyl amides according to 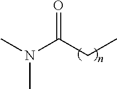
where n is 6-10, or 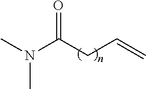
where n is 5-9.

15. The method of claim 9, wherein the method further comprises providing the third solvent comprises at least one of a vegetable oil, an esterified vegetable oil, a paraffinic oil, and an aromatic oil.

16. The method of claim 9, wherein dissolving the at least one PGR comprises dissolving into the binary system at least one of a gibberellin, a cytokinin, an auxin, GA3, GA4, GA7, kinetin, indole-3-butyric acid, cis-jasmone, brassinosteroids, salicylic acid, and methyl salicylate.

17. A method of delivering an agrochemical formulation to plants or seeds, wherein the method comprises:
dissolving at least one plant growth regulator (PGR) and at least one emulsifier in a non-aqueous solvent system to produce the agrochemical formulation;
adding the agrochemical formulation to an aqueous solution of a spray tank, wherein the agrochemical formulation and the aqueous solution spontaneously form an emulsion defining a spray tank solution; and
spraying the spray tank solution onto the plants or seeds.

18. The method of claim 17, wherein:
dissolving at least one plant growth regulator (PGR) and at least one emulsifier in a non-aqueous solvent system comprises dissolving at least one plant growth regulator (PGR) in a mixture of a first solvent and a second solvent defining a binary solvent system, wherein a dielectric constant of the first solvent is greater than a dielectric constant of the second solvent;
and the method further comprises diluting the binary solvent system with a third solvent to form the agrochemical formulation, wherein a dielectric constant of the second solvent is greater than a dielectric constant of the third solvent.

19. The method of claim 17, wherein the non-aqueous solvent system comprises a first solvent, a second solvent and a third solvent, and wherein the method further comprises:
providing the first solvent comprising at least one of dimethyl sulfoxide (DMSO), dimethylformamide (DMF), N-methyl-2-pyrrolidone (NMP), and propylene carbonate;
providing the second solvent comprising an N,N-dimethyl amide or a mixture of N,N-dimethyl amides according to 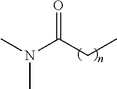
where n is 6-10, or 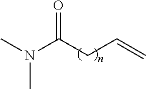
where n is 5-9; and
providing the third solvent comprising at least one of a vegetable oil, an esterified vegetable oil, a paraffinic oil, and an aromatic oil.

20. The method of claim 17, wherein dissolving the at least one PGR comprises dissolving into a binary system at least one of a gibberellin, a cytokinin, an auxin, GA3, GA4, GA7, kinetin, indole-3-butyric acid, cis-jasmone, brassinosteroids, salicylic acid, and methyl salicylate.
